(19) United States
(12) Patent Application Publication
(10) Pub. No.: US 2014/0188528 A1
(43) Pub. Date: Jul. 3, 2014

(54) Customized Advertisement for Venue Seat Map

(71) Applicant: STUBHUB, INC., San Francisco, CA (US)

(72) Inventors: Oliver Oxenham, San Francisco, CA (US); Wesley Oxenham, San Francisco, CA (US)

(73) Assignee: STUBHUB, INC., San Francisco, CA (US)

(21) Appl. No.: 13/732,225

(22) Filed: Dec. 31, 2012

(51) Int. Cl. G06Q 30/02

(52) U.S. Cl. CPC G06Q 30/0253
USPC 705/5

(57) ABSTRACT

Computing systems and methods for providing customized advertisements on virtual venue seat representations or maps during the review and/or purchase of event tickets by customers include storage components that store information regarding ticketed events and venue information for seating arrangements, and also one or more processors that conduct activities regarding providing the customized advertisements during the review and purchase of tickets. Actions include providing a display on a computing device including information regarding a venue that is used for ticketed events, accepting on the computing device a user input regarding tickets or seating arrangements for the venue, determining an attendance location for a ticketed event at the venue based upon the input, generating a representation or map of a region of interest at the venue from the determined attendance location, creating a customized advertisement for the user, and displaying to the user the customized advertisement within the representation or map.

### TECHNICAL FIELD

The present disclosure relates generally to electronic commerce, and more particularly to the presentation of seating arrangements associated with automated ticket transactions.

### BACKGROUND

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket. Many different websites and parties buy, sell and provide marketplaces for tickets online, and the ability for individuals to buy and sell tickets online is now generally well known. These tickets can be for a variety of live events, such as, for example, sports, concerts, theater, and other entertainment events. In many instances, a buyer looks for available tickets on a ticket marketplace or other online listing and decides which, if any, of the available tickets are of interest to the buyer for possible purchase. The buyer can be provided with information such as an event date and time, venue, the price of the tickets, prices of closed listings (both sold and unsold), and location of the tickets, such as through a seating chart of the venue. Based on these and possibly other informational items, the user can select desired tickets from among multiple listings at the same website or online presence.

In many instances where event tickets are bought and sold online or via other electronic transactions, a seat map and or virtual seat representation can be displayed to the user. Such seat maps or virtual seat representations are generally intended to reflect seating arrangements or views from a venue of interest, such that the user has a good or better idea of where he is she might be selling or buying tickets for a given event at a given venue. Unfortunately, such seat maps or presentations can be relatively simplistic given the vast data transmission speed and processing power that is typically available to many users of such ticket commerce websites. As such, various opportunities for a website or content provider to cater or market to many users may be lost through the use of such simple seat presentations.

Although many systems and methods for purchasing tickets and attending ticketed events have generally worked well in the past, there is always a desire for improvement. In particular, what is desired are systems and methods that provide ticketing website operators with greater abilities to cater and market to specific users, while providing potential ticket purchasers with more robust and informative ways to select and purchase tickets to various ticketed events.

### BRIEF DESCRIPTION OF THE DRAWINGS

The included drawings are for illustrative purposes and serve only to provide examples of possible systems and methods for the disclosed customized advertisements for venue seat maps. These drawings in no way limit any changes in form and detail that may be made to that which is disclosed by one skilled in the art without departing from the spirit and scope of this disclosure.

FIG. 1 illustrates in block diagram format an exemplary computing system adapted for implementing the purchase of tickets for ticketed events according to one embodiment of the present invention.

FIG. 2 illustrates in block diagram format an exemplary computer system suitable for implementing on one or more devices of the computing system in FIG. 1 according to one embodiment of the present invention.

FIGS. 3A-3B illustrate screenshots of exemplary service provider pages depicting overhead graphical representations of venues for ticketed events of interest according to various embodiments of the present invention.

FIGS. 4A-4C illustrate screenshots of exemplary service provider pages depicting graphical representations of one particular venue for ticketed events of interest including customized advertisements according to various embodiments of the present invention.

FIG. 5 illustrates a screenshot of another exemplary service provider page depicting a graphical representation of another venue for ticketed events including customized advertisements according to one embodiment of the present invention.

FIG. 6 provides an exemplary data storage arrangement for a customized advertisement account system according to one embodiment of the present invention.

FIG. 7 provides a flowchart of an exemplary method of providing customized advertising during a ticket transaction for a ticketed event according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

The present invention relates in various embodiments to devices, systems and methods involving activities with respect to the online purchase of tickets to ticketed events. In various particular embodiments, the subject devices, systems or methods can involve one or more user devices in communication over a network. Such a network can facilitate the improved discovery, perusal and purchase of tickets online. The subject systems or methods can utilize seat maps and/or virtual seat representations to display venues or portions thereof to users, and are able to provide customized advertisements on these seat map and virtual seat representation displays. This can allow for ads that are targeted to known users in some instances.

In general, a venue seat map or virtual seat representation can have metadata that allows the map and advertisements thereon to be customized for each user. Advertisements can be specific and targeted to individuals based on information or profile data for known users or viewers, and/or can be specific to the venue, such as when users select or see a particular seat view or venue view. In addition, the various customized advertisements can appear as part of the actual venue, as opposed to simple overlaid banners or logo advertisements.

While the various examples disclosed herein focus on particular aspects regarding providing customized advertisements during the review and purchase of tickets electronically, it will be understood that the various inventive principles and embodiments disclosed herein can be applied to other types of ticketed applications and arrangements as well. For example, a ticket purchase done on a closed or proprietary computing system may utilize one or more of the aspects and features found in the various systems and methods provided.

### Systems and Devices

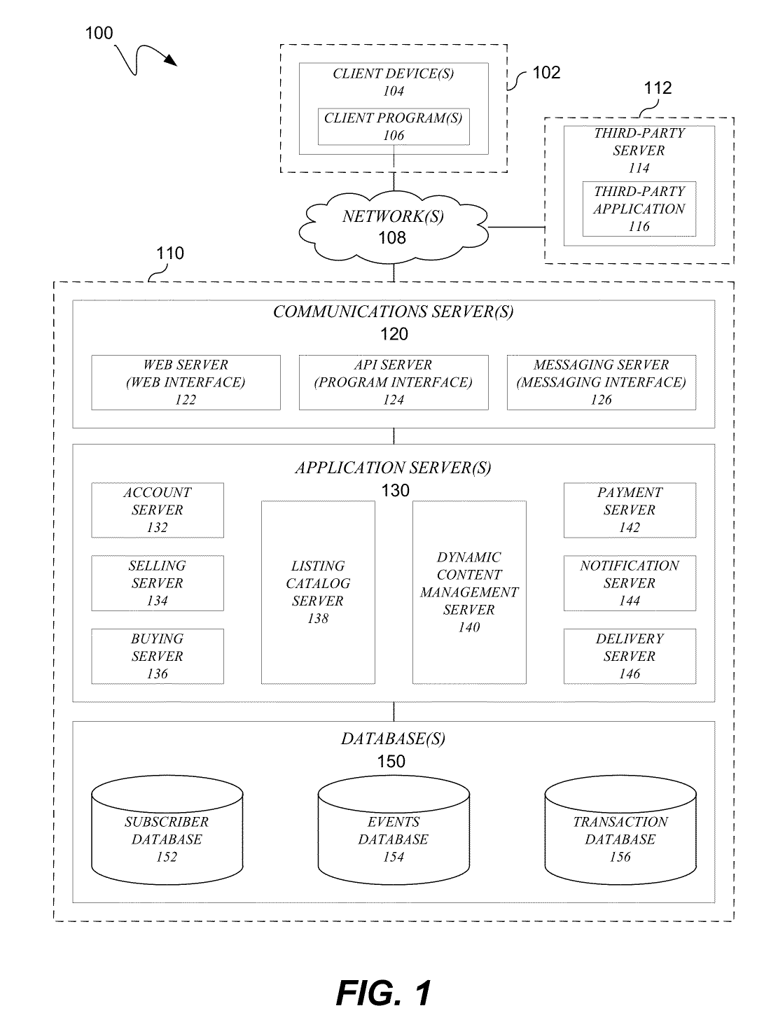

Beginning with FIG. 1, an exemplary embodiment of a computing system adapted for implementing the purchase of tickets for ticketed events is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. It is also specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as additional ticket inventory. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services. Various ways of constructing and displaying customized advertisements during the reviewing, selling, listing and buying of tickets, as set forth in detail below, can be included in dynamic content management server 140, or can be by way of a separate specialized server.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments. Data and information relating to the constructing and displaying of customized advertisements during the reviewing, selling, listing and buying of tickets, as set forth in detail below, can be included in one or more of databases 152, 154, 156, and/or can also be included in a separate database dedicated for this purpose. Further details regarding the various components, capabilities and features of computing system 100 can be found at, for example, U.S. patent application Ser. No. 13/293,854, entitled “Intelligent Seat Recommendation,” filed on Nov. 10, 2011, which is incorporated herein by reference in its entirety.

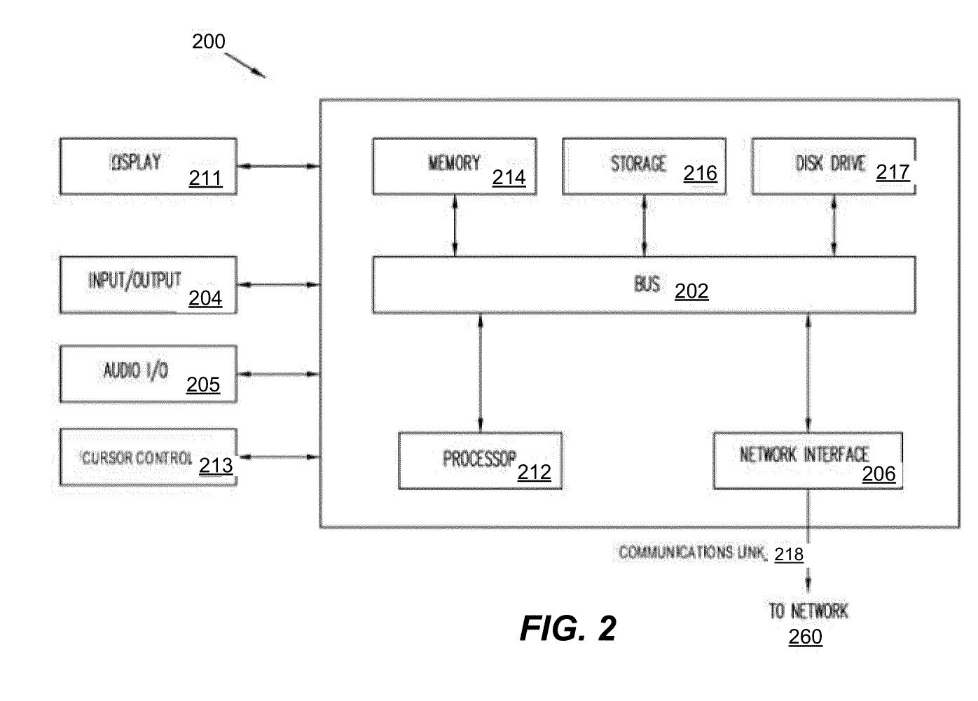

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both.

### Customized Advertisements for Venue Seat Maps

As will be readily appreciated, the foregoing networks, systems, devices, methods and variations thereof can be used to implement a more robust way of providing advertisements to users on ticket transaction websites and networks. Rather than resorting to banners, logos, video clips and other known (and often annoying) devices and techniques for advertising to users who review, list, sell, and buy tickets to events electronically, website operators and other network content providers can utilize a more user friendly advertising system. In particular, such an advertising system can customize advertisements to users in a more targeted, personal and aesthetically appealing way. In various embodiments, customized advertising to a user during a user review, ticket selection and/or purchase using such a seat map or other virtual venue representation can be facilitated by an online service or content provider, such as, for example, StubHub, Inc. of San Francisco, Calif.

In various embodiments, ticketed events can be social or recreational events, such as concerts, musicals, shows, fairs, amusement parks, sporting events and the like. Alternatively, such events can be business related events, such as business meetings, conferences, retreats, and the like. In various embodiments, one or more networks, systems, devices and methods that provide custom advertisements to users while reviewing, selecting and purchasing tickets can use a two-dimensional seat map, three-dimensional seat map, and/or some other virtual venue display or presentation. Available tickets, sections and/or price ranges can be obtained or provided to the user by way of structured data from the service provider and/or other sources. Such data can be presented to the user in a manner so as to readily facilitate the selection and purchase of tickets with respect to preferred sections, seats, concessions and/or pricing options that may be suitable. Such section or pricing options can be variable or varied depending upon the number of tickets desired and preferred section or pricing parameters.

One way to facilitate providing users with information to make more intelligent and informed way to select and purchase tickets to various ticketed events can involve providing an enhanced two-dimensional seat map. Such a seat map or interface can involve two-dimensional views or maps created from three-dimensional models, augmented realities, or both. This seat map for a venue can be created using 3GS, 4GS, HTML4, HTML5, or any other suitable mapping language or protocol. The use of SVG can allow layers to be presented for a more robust presentation, even on mobile devices. Such a map presentation involving 3D representations can be used in conjunction with a 2D map to show sections and rows around the venue in a more effective manner. Toggling back and forth between the 2D and the 3D maps can then take place when a user desires to see what the view looks like from a particular seating location on a simpler but more distributed 2D map.

In various embodiments, a user can access a ticket listing, selling, reviewing and buying interface from any suitable remote location with any suitable computer or device. Such remote access can involve taking a virtual “walk” around the venue, seeing available seats and prices at different places along the walk, and possibly purchasing one or more tickets after seeing the view from each seat or other attendance location of interest. In some embodiments, a user can access an interactive seat map or interface while he or she is physically present at or near the venue, such as by way of a smart phone or other personal mobile device. This can allow a user to see virtually what a view looks like at a different venue location, and can even allow the user to see what the virtual views look like from the exact location of the user. Various other features and techniques for listing, reviewing and facilitating ticket sales for ticketed events are also possible, and it is specifically contemplated that all such suitable features and techniques can be included with the disclosed customized advertising systems and methods herein.

As noted with respect to FIG. 2 above, a computer system 200 can include one or more processors 212 and one or more memories or storage devices 214, 216. Such a computer system 200 can be part of a user device, part of one or more servers on a network-based system, or some combination thereof. In various embodiments, one or more of the processors 212 of interest can be located on the user device only, on the server side only, or on both. Similarly, one or more of storage devices 214, 216 can be located on the user device only, the server side only, or on both. A given computing system can include one or more memory devices or storage components 214, 216 adapted to store event information regarding one or more upcoming ticketed events, venue information regarding seating arrangements and views from seats, and/or images and information used to generate virtual views. Storage can also include information about known users and also customized advertisements data, such that customized advertisements can be provided and displayed to users. In addition, one or more processors 212 can be in communication with the one or more memory devices or storage components and can be adapted to facilitate providing a display on a computing device to a user thereof, the display including information regarding a venue that is used for one or more ticketed events, and also customized ads.

Further functionality of the one or more processors 212 can include the ability determine the identity of a user, such as when a user logs in, and also the ability to provide data regarding the venue and/or data regarding the user for advertising purposes. Additional functionality can be to accept on the user computing device a first input from the user regarding seating arrangements for the venue, determine a first attendance location for a ticketed event at the venue based upon the first input, generate a first virtual view of a region of interest at the venue from the determined first attendance location, provide customized advertisements, and display to the user the first virtual view and the customized advertisements.

The first virtual view can include customized advertisements that are embedded therein, and can be displayed on the same display component that displays the information regarding the venue, such as on a sole or primary display of a user computing device, smart phone or mobile device. In various embodiments, the computing system can also include a display component adapted to display to the user the first virtual view. Further, the attendance location can be a specific seat at the venue selected by the user, such as while the user is physically at the selected seat. In various embodiments, the one or more processors 212 can be located on a server while the display and user inputs can be located on a remote mobile user device, such as a smart phone.

Various screenshots of exemplary pages from a potential service provider having seat maps, virtual seat views, and customized advertisements embedded therein will now be provided for purposes of illustration. It will be understood that such screenshots and pages are not intended to be limiting, and that these merely provide examples of what such pages may contain. Furthermore, not every noted page need be provided for a given service provider, and additional pages not shown or described might also be included in some instances.

In various embodiments, it is specifically contemplated that enhanced venue seat maps and virtual venue seat views or representations having customized advertisements be provided. Such items can be provided as displays to a user on a computing device, such as the personal computer or personal mobile device of the user, and as such can be present as part of one or more specialized applications or “apps” that can be provided to device users. As such, the software or apps can be programmed, provided and/or serviced by one or more separate content providers on one or more remote system servers. Such one or more remote system servers can also be adapted to interact with the apps on user devices to facilitate a smooth and streamlined presentation, advertising and purchase process for users.

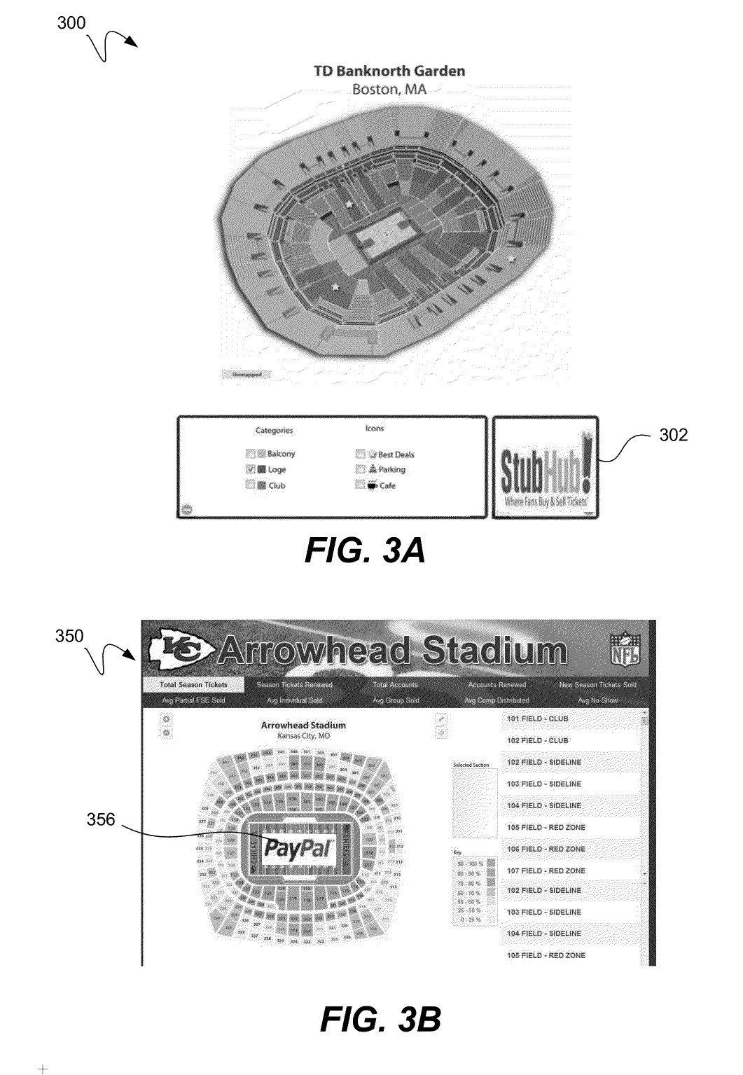

Turning next to FIGS. 3A-3B, screenshots of exemplary service provider pages depicting overhead maps or graphical representations of venues for ticketed events of interest are provided. As shown in screenshot 300 in FIG. 3A, an overhead yet somewhat perspective based graphical overall representation of TD Banknorth Garden in Boston is provided. This map shown in screenshot 300 is somewhat three-dimensional yet comprehensive, and can allow a user to more readily see a full or partial two-dimensional seat map of the venue, such as upon the selection of a section or region of interest in a quick and efficient manner. Customized advertisement 302 provides one example of a banner type advertisement for such a comprehensive overhead seat map page in screenshot 300.

Similarly, FIG. 3B provides a screenshot of an overhead map 350 of Arrowhead Stadium, which also allows a user to readily select a given section or region. Customized advertisement 356 provides another example of an advertisement for the similar comprehensive overhead seat map page in screenshot 350. Unlike the banner advertisement 302 above, customized advertisement 356 is more embedded within the actual image, such as on the field within the seat map. Further actions, such as three-dimensional rendering, different view presentations, seat selection, ticket purchase, and so forth based on these initial selections can then follow, with suitable customized advertisements being embedded within the venue seat map, virtual seat views or otherwise presented or displayed as may be appropriate.

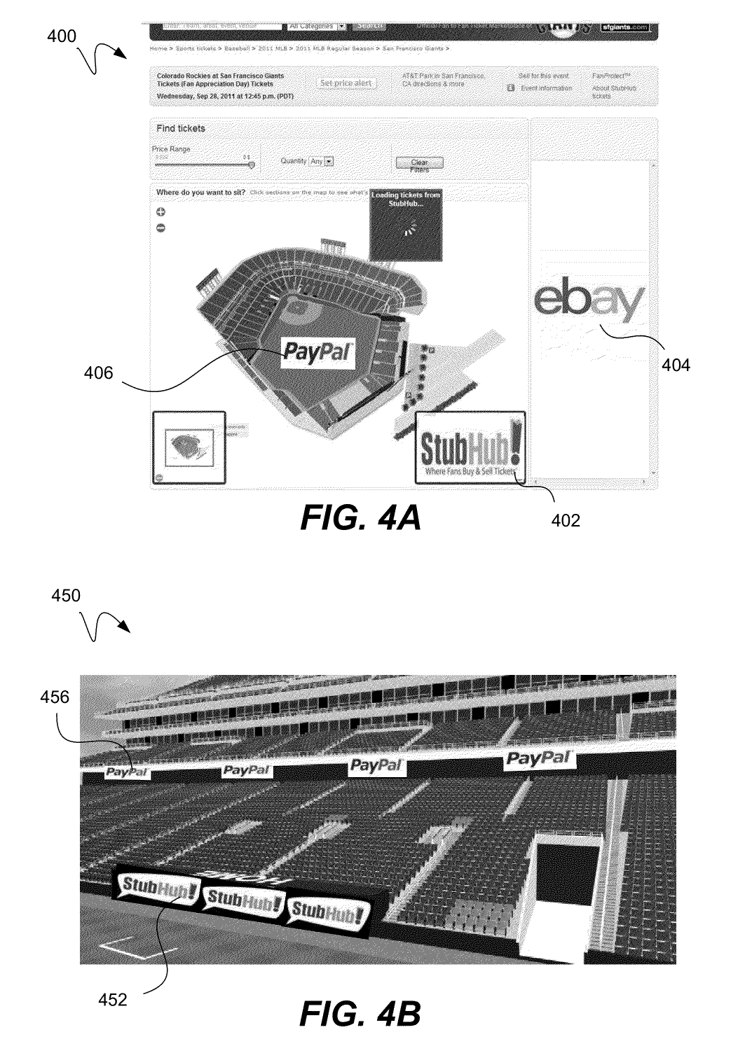

Continuing with FIGS. 4A-4C, various further screenshots of exemplary service provider pages depicting graphical representations of one particular venue for ticketed events of interest including customized advertisements are provided. Starting with screenshot 400 in FIG. 4A, an online ticket search page for a baseball venue is shown. The page shown includes a virtual representation of the ballpark, which is AT&T Park in San Francisco. It will be readily appreciated that the various venue depictions, overhead maps, 2D and 3D views provided to a user of the service provider can be generated in a number of ways. In various provided pages, one or more customized advertisements can be embedded, such as customized ads 402, 404 and 406 by three different advertisers. While some of the customized advertisements can be banner ads or other labels or logos, others can be embedded within the venue seat map or representation itself, such as advertisement 406.

Screenshot 450 in FIG. 4B depicts one particular portion of the overall venue shown in FIG. 4A. Specifically, the lower and midlevel seats along the first baseline of the baseball venue are shown. In addition, multiple customized billboard advertisements 452 and dugout placards 456 are also shown in this virtual view of the venue. Again, such advertisements can be embedded within the venue map or seating representation, preferably in a manner that appears more natural and aesthetically pleasing to the user. In various embodiments, the nature of such embedded advertisements can resemble the nature of the advertisements that actually exist at the venue, such as in the form of billboards, placards, displays and other real signage along rails, walls, scoreboards and the like. As will be readily appreciated, the digital creation and provision of such advertisements can allow for a much more varied and different selection of advertisements compared with the actual physical billboards and other signage that might exist at the actual venue.

Continuing with FIG. 4C, screenshot 480 displays another virtual view of the venue, this time from behind home plate. From this view, various other types of customized advertisements can be embedded as the actual scoreboard 482, associated scoreboard signage 484, and on field virtual display ad 486. Other types and locations for such virtual and customized advertisements can be along the outfield walls, at various overhangs, on actual seats or railings, on a backstop, or at any other number of locations that might be envisioned. In addition, many more advertisements can be added as may be appropriate or desired by a particular site operator.

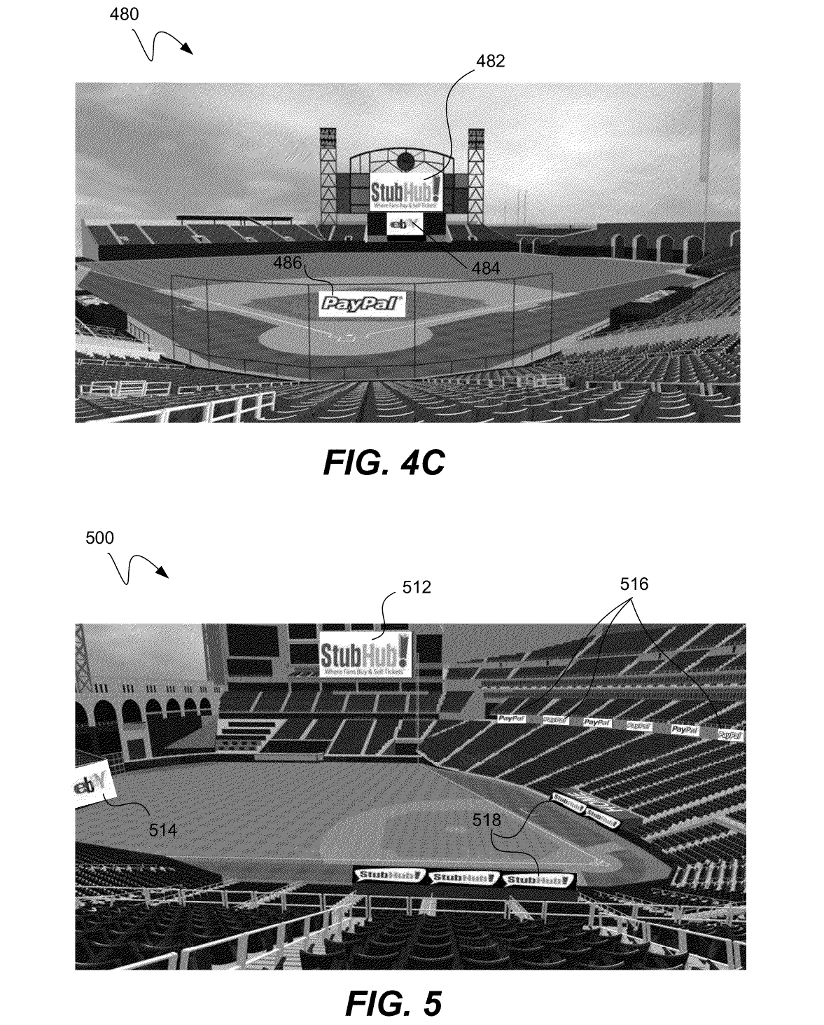

FIG. 5 illustrates a screenshot of another exemplary service provider page depicting a graphical representation of another venue for ticketed events including customized advertisements according to one embodiment of the present invention. Screenshot 500 can be of another venue, such as Minute Maid Park in Houston. Again, customized advertisements 512, 514, 516 and 518 can be embedded within the seat map or virtual seat presentation at locations that appear to be more natural and pleasing to the viewer, such as on scoreboards, outfield walls, dugouts and midlevel overhangs or railings. Again, other locations might also be used, such as on actual seats or cupholders in views that are even more zoomed.

While the various customized advertisements depicted have been with respect only to StubHub, eBay and PayPal, it will be readily appreciated that a vast number of other vendors and entities can also be advertised. Thousands or even millions of customized advertisements in formation, presentation, and different advertising entities can be used, and it is specifically contemplated that any and all such suitable ads can be embedded within the seat map images or representations. Such advertisements can be customized based upon known information about the actual user browsing the site, based upon the particular region, section or seat views being pulled up by the user, other factors, or any combination thereof.

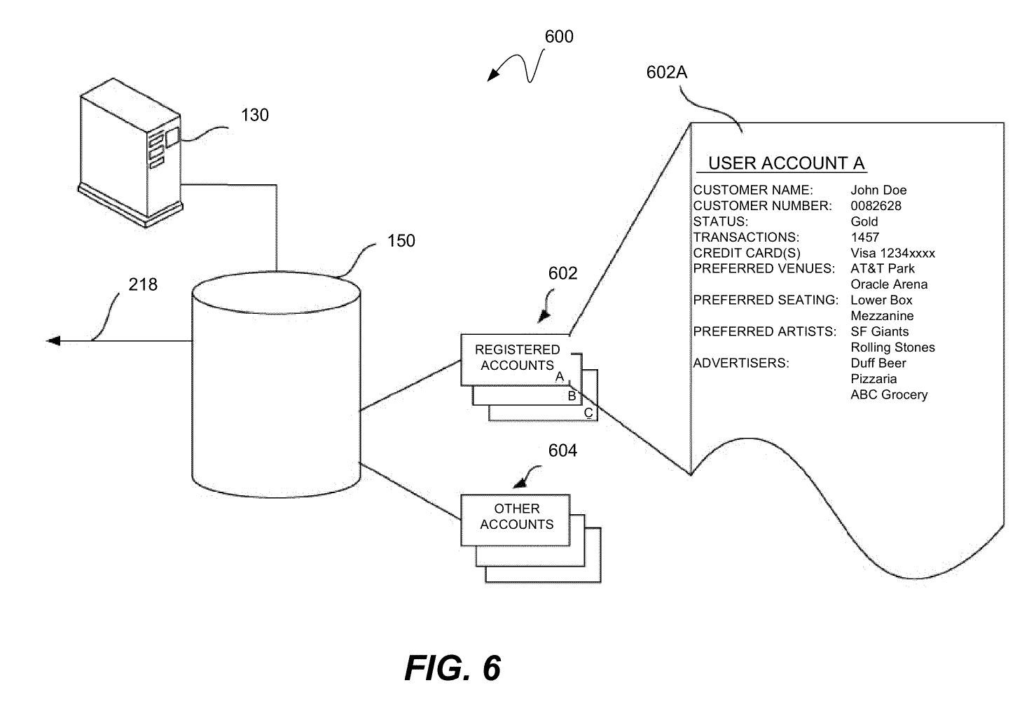

Turning now to FIG. 6, an exemplary data storage arrangement for a customized advertisement account system is disclosed. In various embodiments, customized advertisement system 600 can include one or more special purpose servers 130 adapted for user profiling and/or customized advertisements, which can be coupled to one or more specialized user profiling and/or customized advertisement databases 150. The special purpose database(s) 150 and/or server(s) 130 can be coupled to a WAN and/or over the Internet by way of one or more communications links 218, as will be readily appreciated.

The database(s) 150 can hold various forms of data for the purpose of providing customized advertisements, which data can be organized by way of regular registered user accounts or profiles 602 in addition to a plurality of anonymous, unregistered or other user accounts or profiles 604. The system 600 can provide customized advertisements to each registered and unregistered user as may be appropriate. As shown, such user accounts or profiles can be separated or otherwise designated as registered accounts 602 and unknown or other accounts 604, or may not be so separated, as may be desired. In either circumstance, the user accounts or profiles can be similar for both registered and unknown users. That is, registered user accounts may contain known information for registered users, such as actual names, numbers, statuses, credit card information, addresses, past usage history, and the like. Such information can be based upon past transactions within the ticket review, listing, selling and buying system. Data can also include information regarding recent page views, detected cookies, and other pertinent information that can be used to create and provide targeted or customized advertisements. For unregistered or unknown users, similar user accounts or profiles 604 can simply contain blanks for unknown data, while also containing whatever information might be useful in making custom ads.

Exemplary registered user account or profile 602A can contain a variety of information regarding the user. Where the user name or other information is not known, a simple “unknown” or blank can be used in the appropriate field. Other information can include, for example, a user or customer number, a current user status or level, the number, type and details of previous ticket transactions on the site for the user, and user preferences, such as with respect to venues, seating and sports teams, artists or acts. In addition, known preferences of the user with respect to products and other potential items of interest for advertisers can be kept on file. In the event of anonymous, unregistered, or otherwise unknown users, advertisements can be customized and targeted based upon what little information might be available. For example, page views, cookies, other recent transactions, and other actions might provide details as to what might appeal to an unknown user for purposes of providing customized advertisements during later seating, map or page views.

### Methods

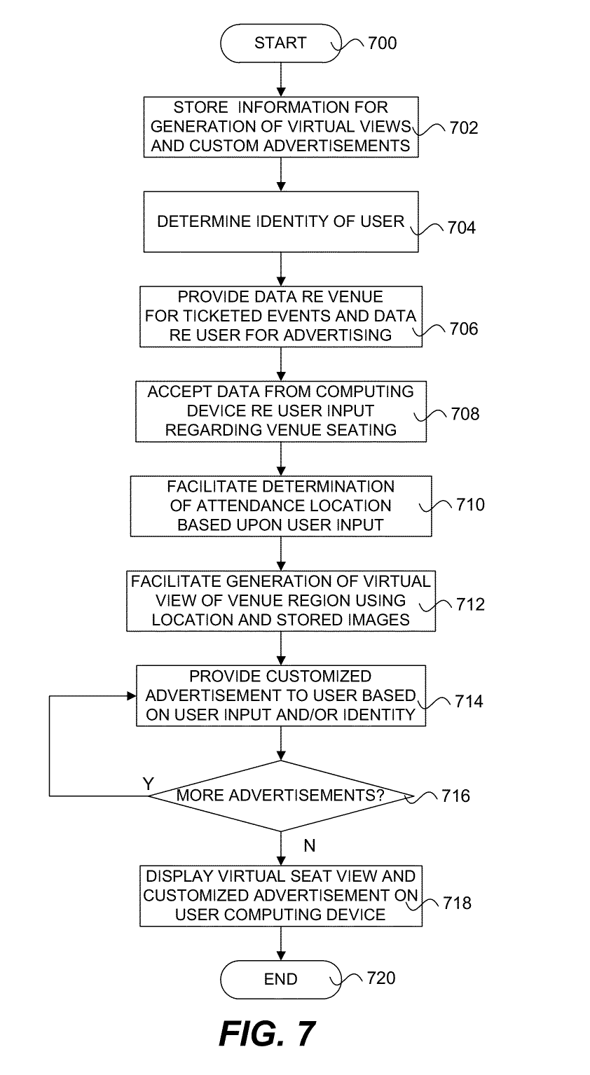

Although a wide variety of applications and methods involving the use of customized advertisements for venue seat maps might be envisioned, one basic method is illustrated here. Turning lastly to FIG. 7, a flowchart of an exemplary method of providing customized advertising during a ticket transaction for a ticketed event using a venue seat map is provided. In particular, such a method can involve using or operating any of the various computing components, devices, systems and/or networks described above. It will be readily appreciated that not every method step set forth in this flowchart is always necessary, and that further steps not set forth herein may also be included. For example, additional steps can include suggesting ticketed events, accepting payments, and delivering tickets, among others. Furthermore, the exact order of steps may be altered as desired for various applications. For example, step 702 can be performed in a number of different locations in the process, such as after step 710. Further, step 716 need not be performed in all cases, for example.

Beginning with a start step 700, images and/or information that can be used for the generation of virtual views, as well as information that can be used for the provision of customized advertisements can be stored at process step 702. Such images and information for seat maps or virtual views can include publicly available information, such as that which is readily available on the Internet, as well as private and/or proprietary information from any of a number of different sources. Such information for users and other sources for customized advertisements can be stored on user and/or advertiser information databases, such as that which is set forth above. This stored information can be updated or augmented over time, as may be useful or suitable for a given service provider.

The identity of a user can be identified at process step 704 in some embodiments. Of course, the method can still be practiced if the user is not identified, such as in the case of unknown or unregistered users. Such instances might simply involve less information that can be used to create the customized advertisements for display. Data or information regarding a given venue for ticketed events can then be provided to and/or used for generating a display on a user computing device, such as a phone or other mobile device, at process step 706. A user input regarding selecting or designating one or more seat locations or other venue regions of interest can be accepted at process step 708, after which the facilitation of a determination of an attendance location based upon the user input can be made at process step 710. It will be understood that not every attendance location need be a seat, such as in the case of standing room only, pavilion, general admission and other nonseated ticket categories. Furthermore, some embodiments may permit a user to see virtual two-dimensional views and/or virtual three-dimensional views from alternative locations, such as certain aisles, concourses, restrooms and concessions stands, for example.

At subsequent process step 712, facilitation of generating a virtual view with respect to the determined location can be performed. Such facilitation can be had on processor(s) on the user device itself. In some embodiments, facilitation can be performed by processor(s) on a remote server, with the actual generation of virtual views being performed either on the remote server as well or on the user device due to the activities of the remote server.

At process step 714, an advertisement customized to the user can be provided. Again, such an advertisement can be customized based upon the input of the user (e.g., reviewing premium seats) and/or based upon the known identity of the user (e.g., John Doe, who likes Duff Beer). At the following decision step 716, an inquiry can be made as to whether or not more customized advertisements are to be provided. If so, then step 714 is repeated. When all of the desired customized advertisements have been provided, then the method continues to process step 718, where a display is provided to the user, such as on the computing device of the user. The display includes the virtual seat view or map, as well as all of the provided customized advertisements. Again, one or more of the advertisements can be embedded within the virtual seat map or presentation. The method can then finish at end step 720.

Further steps not depicted can include, for example, accepting further input(s) from the user and providing other seat views or maps accordingly, or accepting user inquiries as to amenities such as concessions or restrooms with respect to a given attendance location. Other process steps can include, for example, facilitating a ticket purchase and ticket delivery by the user, and/or interacting with third party advertisers to accept content, provide accounting and accept revenue for the placement of customized advertisements to users.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A computing system, comprising:
one or more communication interfaces adapted to couple the computing system to a remotely located computing device;
one or more storage components adapted to store event information regarding one or more ticketed events, venue information regarding seating arrangements, seat views or information adapted for use in facilitating the generation of virtual views, advertisement information adapted for the provision of customized advertisements with respect to a user, or any combination thereof; and
one or more processors in communication with the one or more communication interfaces and the one or more storage components, said one or more processors being adapted to provide data to be displayed on the remotely located computing device to a user thereof, the data including information regarding a venue that is used for one or more ticketed events, information regarding advertisements that are customized to the user, or both, wherein said one or more processors are further adapted to facilitate the generation of a virtual view of a region of interest at the venue, facilitate the provision of a first customized advertisement to the user based upon a user input, the identity of the user, or both, and facilitate the presentation of a graphical display to the user on the remotely located computing device involving the virtual view and the first customized advertisement.

2. The computing system of claim 1, wherein the first customized advertisement is embedded within the virtual view.

3. The computing system of claim 1, wherein said one or more processors are further adapted to facilitate the provision of a second customized advertisement to the user based upon a user input, the identity of the user, or both, and wherein the graphical display to the user includes the first and second customized advertisements.

4. The computing system of claim 1, wherein said one or more processors are further adapted to facilitate accepting data from the computing device, the data including information regarding an input from the user concerning seating arrangements for the venue, and to facilitate a determination of a first attendance location for a ticketed event at the venue based upon the first input.

5. The computing system of claim 1, wherein the remotely located computing device is a mobile device.

6. The computing system of claim 1, wherein the virtual view is generated from images, information or both that are stored on the one or more storage components.

7. The computing system of claim 1, wherein said one or more processors are further adapted to determine the identity of the user.

8. The computing system of claim 1, wherein the provision of a first customized advertisement to the user is based upon data within a user profile for a known user, said user profile data including information regarding past transactions of the user.

9. A non-transitory medium having a plurality of machine-readable instructions which, when executed by one or more processors of a server controlled by a service provider, are adapted to cause the server to perform a method comprising:
providing data to be displayed on a computing device to a user thereof, the data including information regarding a venue that is used for one or more ticketed events, said providing being performed electronically by a processor;
accepting data from the computing device, the data including information regarding a first input from the user concerning seating arrangements for the venue;
facilitating a determination of a first attendance location for a ticketed event at the venue based upon the first input;
facilitating the generation of a first virtual view of a region of interest at the venue from the determined first attendance location;
facilitating the provision of a first customized advertisement to the user based upon the first input, the identity of the user, or both; and
facilitating the presentation of a graphical display to the user on the computing device involving the first virtual view and the first customized advertisement.

10. The non-transitory medium of claim 9, wherein the method further includes the step of:
determining identity of the user.

11. The non-transitory medium of claim 9, wherein the method further includes the step of:
storing information regarding the user, wherein the stored information is used in providing the first customized advertisement.

12. The non-transitory medium of claim 9, wherein the method further includes the step of:
facilitating the provision of a second customized advertisement to the user based upon the first input, the identity of the user, or both, wherein the graphical display to the user also includes the second customized advertisement.

13. The non-transitory medium of claim 9, wherein the first customized advertisement is embedded within the first virtual view.

14. A method of providing customized advertising during a ticket transaction for a ticketed event, the method comprising:
providing data to be displayed on a computing device to a user thereof, the data including information regarding a venue that is used for one or more ticketed events, said providing being performed electronically by a processor;
accepting data from the computing device, the data including information regarding a first input from the user concerning seating arrangements for the venue;
facilitating a determination of a first attendance location for a ticketed event at the venue based upon the first input;
facilitating the generation of a first virtual view of a region of interest at the venue from the determined first attendance location;
facilitating the provision of a first customized advertisement to the user based upon the first input, the identity of the user, or both; and
facilitating the presentation of a graphical display to the user on the computing device involving the first virtual view and the first customized advertisement.

15. The method of claim 14, wherein the computing device is owned by the user.

16. The method of claim 15, wherein the computing device is a cellular telephone.

17. The method of claim 14, further including the step of:
determining identity of the user.

18. The method of claim 14, further including the step of:
storing information regarding the user, wherein the stored information is used in providing the first customized advertisement.

19. The method of claim 14, further including the step of:
facilitating the provision of a second customized advertisement to the user based upon the first input, the identity of the user, or both, wherein the graphical display to the user also includes the second customized advertisement.

20. The method of claim 14, wherein the first customized advertisement is embedded within the first virtual view.
